(19) United States
(12) Patent Application Publication
(10) Pub. No.: US 2013/0199629 A1
(43) Pub. Date: Aug. 8, 2013

(54) LOW TEMPERATURE CAPABLE LPG TANK HEATER & PRESSURE ACCUMULATOR

(71) Applicant: Geoffrey Hemsley, Kitchener (CA)

(72) Inventor: Geoffrey Hemsley, Kitchener (CA)

(73) Assignee: IMPCO TECHNOLOGIES, INC., Santa Ana, CA (US)

(21) Appl. No.: 13/368,199

(22) Filed: Feb. 7, 2012

(51) Int. Cl. F16L 53/00

(52) U.S. Cl. 137/341

(57) ABSTRACT

A system for providing LPG fuel to a fuel consuming unit, the system comprising: a storage tank configured to contain the LPG fuel; a heater configured to transfer heat to at least a portion of the LPG fuel; an accumulator configured to receive a portion of the LPG fuel; wherein the accumulator can apply pressure to the LPG fuel within the accumulator and the pressure being greater than the vapor pressure of the LPG fuel within the accumulator.

### TECHNICAL FIELD

This disclosure relates to fuel systems for engines and other fuel consuming devices and in particular LPG systems for engines including those capable of operation at low temperature.

### BACKGROUND

Liquefied petroleum gas, also called LP gas and LPG, has been used as a fuel source for many years. This fuel displays a noted sensitivity of vapor pressure to temperature, with winter temperatures in northern climates reducing the vapor pressure to a very low level. In sub-zero temperatures, vehicular LPG systems that depend on LPG vapor pressure in the fuel tank to push fuel toward the engine become constrained by the lack of vapor pressure, limiting their ability to operate year-round on LPG.

### SUMMARY

In a first embodiment disclosed herein is a system for providing LPG fuel to a fuel consuming unit, the system comprising: a storage tank configured to contain the LPG fuel; a heater configured to transfer heat to at least a portion of the LPG fuel; an accumulator configured to receive a portion of the LPG fuel; wherein the accumulator can apply pressure to the LPG fuel within the accumulator and the pressure being greater than the vapor pressure of the LPG fuel within the accumulator.

In a second embodiment disclosed herein is a system for providing an LPG fuel to a fuel consuming unit, the system comprising: a first LPG fuel delivery route, the first LPG fuel delivery route providing more than about 90% of the LPG fuel consumed by a fuel consuming unit when the LPG fuel exhibits a vapor pressure of less than a first pressure, the first LPG fuel delivery route including an accumulator capable of delivering the LPG fuel at a pressure greater than the vapor pressure of the LPG fuel within the accumulator; and more than about 90% of the LPG fuel consumed by the fuel consuming unit when the LPG fuel exhibits a vapor pressure of greater than a second pressure, wherein the first LPG fuel delivery route is not the same as the second LPG fuel delivery route, wherein the first pressure is less than the second pressure.

In a third embodiment disclosed herein is a control system for an LPG fuel delivery system, the control system comprising: a circuit capable of delivering power to a tank heater from a in an LPG fuel delivery system, and wherein the LPG fuel delivery system comprises a storage tank capable of containing an LPG fuel, a first flow path from the storage tank to a fuel delivery point, a second flow path from the storage tank to the fuel delivery point, an accumulator located along the second flow path, and the tank heater configured to transfer heat to at least a portion of the LPG fuel.

In a fourth embodiment disclosed herein is a system for providing LPG fuel to a fuel consuming unit, the system comprising: a storage tank capable of containing an LPG fuel; a first flow path from the storage tank to a fuel delivery point; a second flow path from the storage tank to the fuel delivery point, wherein the first flowpath and the second flowpath partially coincide; an accumulator located along the second flow path, the accumulator configured to deliver LPG fuel at a pressure above the vapor pressure of LPG fuel within the accumulator; a heater comprising a resistive electrical heating element, and configured to transfer heat to at least a portion of the LPG fuel, wherein the heater is located partially inside and partially outside the storage tank, and comprises a first heat exchanger located at least partially inside the storage tank and is in thermal communication with at least a portion of the LPG fuel within the storage tank, and a second heat exchanger located at least partially outside of the storage tank and is in thermal communication with the first heat exchanger, and an electrical heat source in thermal communication with the second heat exchanger; a controller for switching between utilizing a first energy source and a second energy force, wherein the first and second energy sources provide energy for the heat source, wherein the controller receives electrical input from the second energy source and switches between the first energy source and the second energy source based on the availability or unavailability of the second energy source; and an electricity conditioner, wherein the electricity conditioner converts electricity between AC and DC electricity.

### BRIEF DESCRIPTION OF THE DRAWINGS

FIG. 1 shows the vapor pressure-temperature relationship for some exemplary LPG compositions.

FIGS. 2A and 2B show flow diagrams of two embodiments of a fuel system.

FIGS. 3A-3C shows different arrangements of storage tank and heater.

FIG. 4 shows an electrical diagram of an embodiment of a control system for a fuel system.

FIG. 5 shows a block diagram of an embodiment of a control system for a fuel system.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

LPG fuel can be used as a portable or a stationary fuel source. The material used as the fuel can be propane and/or butane and can include other ingredients or additives as desired. Different formulations can have functional effects, such as a particular vapor pressure profile, odor, energy content, viscosity, density, or other physical or chemical properties.

As used herein, LPG, LPG fuel and LP gas can refer to the gaseous form or a condensed form, or a combination of a gaseous form and a condensed form, as indicated by the context.

LPG fuel systems, sometimes referred to as LP gas systems, can have problems due to low ambient temperatures. As the ambient temperature drops, so can the temperature of the LPG in the storage tank. As the temperature of the LPG falls, the vapor pressure of the fuel also falls.

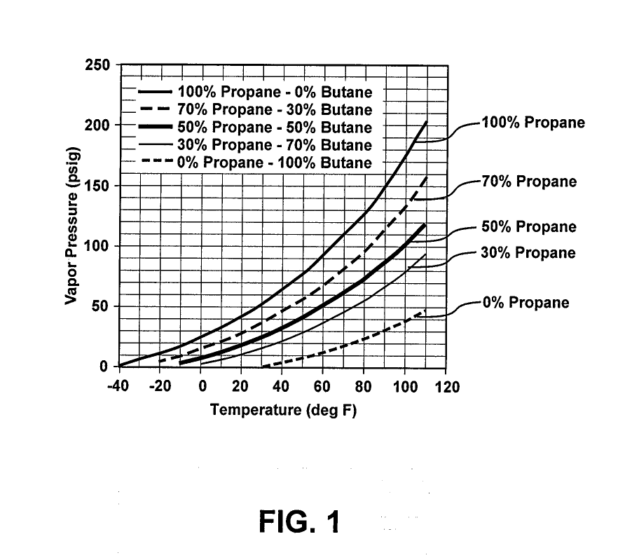

FIG. 1 shows the vapor pressure-temperature relationship for some exemplary compositions of LPG. As can be seen in FIG. 1, the vapor pressure can approach 0 psig for some combinations of temperature and composition.

Many LPG fuel systems utilize the vapor pressure of the fuel to move the fuel from the tank to the engine or other device where it is used. When the vapor pressure falls, the flowrate of the fuel can fall as well, resulting in stalling of the engine and difficulties in starting the engine.

Some LPG fuel systems operate by delivering liquid fuel to the equipment utilizing it. However, these systems can have difficulties in low temperatures due to the availability of too little pressure to force the liquid fuel from the tank and to the equipment utilizing it.

Some LPG fuel systems operate by delivering gaseous fuel to the equipment utilizing it. These systems can have difficulties delivering sufficient gaseous fuel through the system because there is too little pressure to push sufficient fuel to the equipment utilizing the fuel.

Some systems deliver liquid fuel to an evaporator which then delivers vaporized fuel to the equipment utilizing the fuel. Such systems can have difficult delivering fuel, due to the low vapor pressure.

To further confound the problem, LPG fuel system are commonly used for heating, cooking, transportation and backup power generation. These are applications where a high degree of reliability, especially when the ambient temperature is low, is desired. As a result, improved systems for delivering LPG fuel under low ambient temperatures are desired.

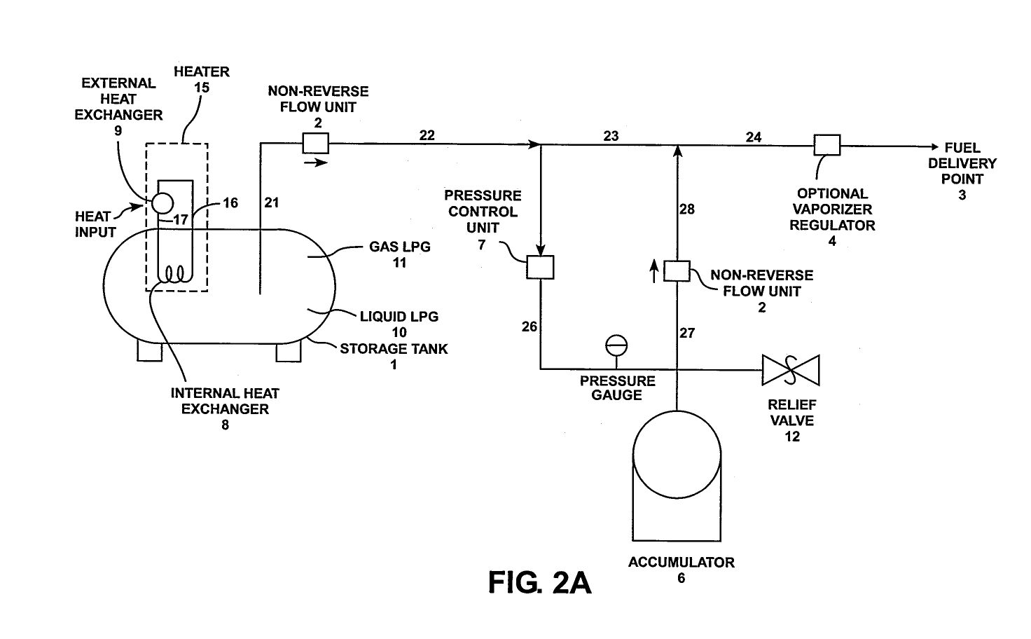

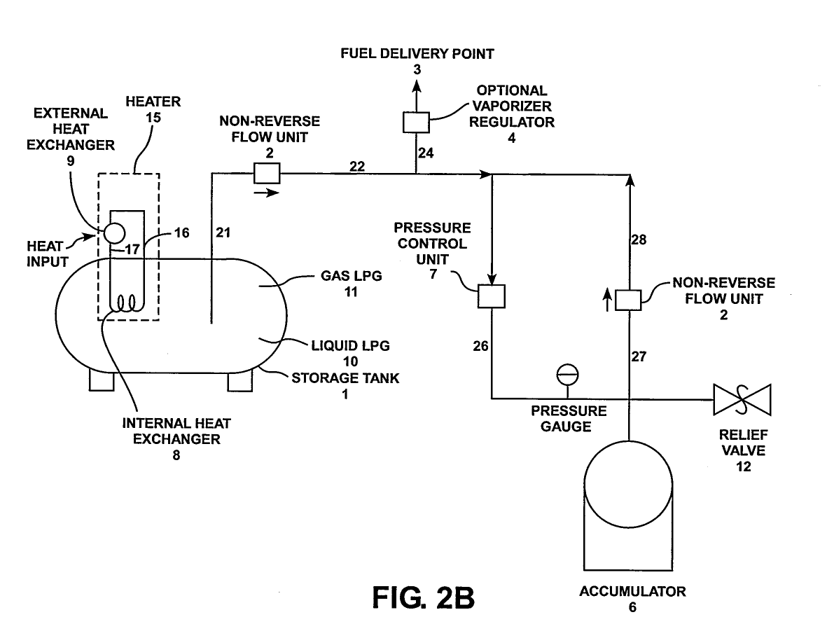

FIGS. 2A and B illustrates a preferred embodiment of a low temperature LP gas delivery system 100. In the illustrated system, a storage tank 1 contains a volume of LPG, as a liquid 10 with a gaseous headspace 11. During Condition 1 operation, liquid LPG travels through line 21, non-reverse flow unit 2, line 22, line 23 (FIG. 2A), line 24 to a fuel delivery point. In some embodiments, the LPG continues on to a vaporizer regulator 4 prior to delivery to a use point.

In addition, during Condition 1 operation, some LPG travels through pressure control unit 7 and line 26 to accumulator tank 6. LPG is typically allowed to build a volume in accumulator tank 6 during Condition 1 operation, for use as further explained below. During Condition 1 operation, the pressure in storage tank 6 forces LPG into accumulator tank 6, however, a pump or compressor or the like can also be used, depending, for example, on preferences for individual systems and particular designs, such as the pressures anticipated to be in the tanks and the operating plans for individual systems.

In some circumstances, including during cold weather or when for other reasons the pressure in storage tank 1 is low or is anticipated to be low, fuel can be supplied either partially or completely from accumulator tank 6. In some embodiments during Condition 2 operation, LPG flows through line 27, pressure control unit 7, line 28, line 24 and to fuel delivery point 3. In some embodiments, LPG can continue on through vaporizer regulator 4 to a fuel use point. A relief valve 12, rupture disk, or other such device can be utilized at accumulator 6, as needed or desired.

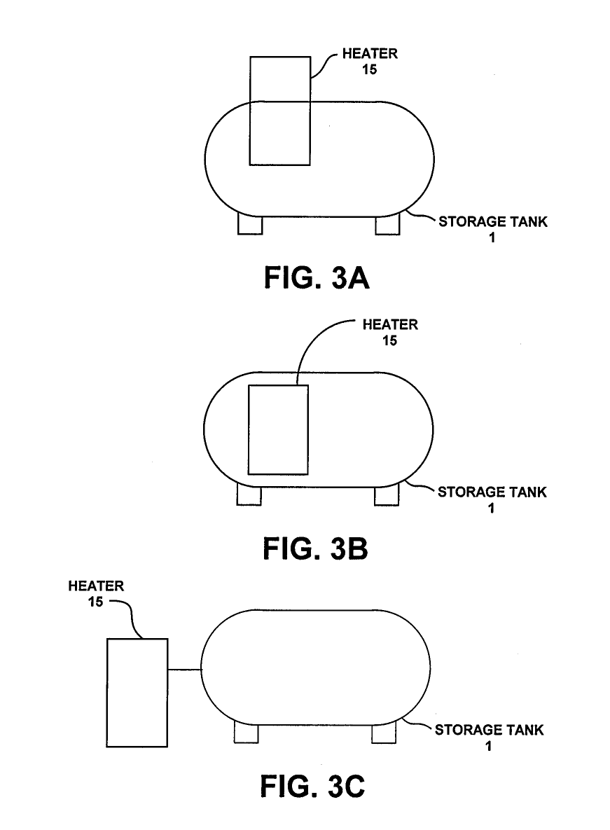

Fuel system 100 also includes a heater 15 that can heat at least a portion of the LPG in storage tank 1. In some embodiments, as shown in FIGS. 2A and 2B, heater 15 can be partially inside storage tank 1 and partially outside storage tank 1. In other embodiments, such as shown in FIG. 3A-3C, heater 15 can be entirely or nearly entirely inside or outside of storage tank 1.

Heater 15, in FIGS. 2A and 2B includes an internal heat exchanger 8, an external heat exchanger 9 and interconnecting lines 16 and 17. During operation of heater 15, energy is input to the heater at external heat exchanger 9 where a heat transfer medium is heated. Heat flows by way of the heat transfer medium through line 16 to internal heat exchanger 8 where at least a portion of the heat carried by the heat transfer medium is transferred to LPG in storage tank 1. In some embodiments, internal heat exchanger 8 can be connected directly to external heat exchanger 9.

### Heat Transfer Medium

Heat transfer medium utilized in the heater can be any suitable material, such as a material that remains a liquid within the heater, material that can be both a liquid and a gas within the heater, material that can be primarily or completely a gas within the heater, and material that is at least in part solid, as well as combinations of these materials.

In some embodiments, a water-based fluid can be used as a heat transfer material, such as a mixture of water and a water conditioning material, such as antifreeze, corrosion inhibitors, viscosity modifiers, surfactants, antimicrobials, and the like.

In some embodiments, a non-aqueous material can be used as a heat transfer material, such as a hydrocarbon, a petroleum-based, or an alcohol, or other polar or nonpolar material. In some embodiments, the non-aqueous material can be a combination of non-aqueous materials.

In some embodiments, a mixture of materials, such as aqueous and non-aqueous or a mixture of aqueous or non-aqueous materials can be used.

In some embodiments, the heat transfer material can exhibit a phase change, such as between liquid and gas. In some embodiments the phase change between a liquid and a gas can be selected to occur at a particular temperature or range of temperatures, such as by operation/design at particular temperatures or ranges of temperatures and by selection of suitable compositions of heat transfer material.

In some embodiments, the conditions for which a phase change to occur in a heat transfer material can be based on the particular fuel being present in the tank and can changed seasonally or when the temperature of the tank or adjacent areas change or can be based on the use the fuel is being used for, such as when a different flowrate or a different delivery pressure is desired.

As can be seen in FIG. 1, different fuel compositions can have different pressure-temperature characteristics. Other properties can change with different fuel composition as well, such as viscosity, heat capacity, latent heat of vaporization, density, heating value, etc. In some embodiments, the heat transfer material can be selected and/or modified in response to one or more of the properties of the fuel, the condition of the environment, the operating conditions of the fuel system or the system the fuel is being delivered to. In some embodiments, the fuel can be selected to provide different delivery or operation parameters for a given heat transfer material. In some embodiments, both the heat transfer material and the fuel composition can be changed.

### LPG

LP gas or LPG commonly includes a mixture of hydrocarbon molecules. The actual composition can vary, whether regionally, seasonally, or by manufacturer/supplier to suit particular needs, but in some cases can have a boiling point of about −40 F to about 30 F at 1 atm absolute pressure, but can also vary from these values. If the pressure increases, the boiling point will go up and when the pressure decreases, the boiling point will go down.

Under certain conditions, it can be a liquid, a gas, or a combination of liquid and gas. Such conditions are generally known and can vary based on the particular material being supplied or used. As used herein, LPG or LP gas is understood to include the material that is commonly referred to as LP gas, and can contain primarily butane or propane and combinations thereof.

In some embodiments, the LP gas can have a composition of more than about 10% (wt.) propane. In some embodiments, the LP gas can have a composition of more than about 20 or more than about 40 or more than 60 or more than about 80 or about 20 to about 60 or about 30 to about 70 or about 40 to about 80% wt. propane. In some embodiments, LP gas can include more than about 10 of butane or more than about 20 or more than about 40 or more than 60 or more than about 80 or about 20 to about 60 or about 30 to about 70 or about 40 to about 80% wt. butane. In some embodiments, the LP gas can be more than 95% wt. butane or propane or more than about 98% wt. butane or propane.

### Storage Tank

A storage tank can be any suitable tank for the application. For example, some applications, such as for automobiles or home use, can find small size and low weight advantageous, while in other applications, such as some trucking and other mobile or stationary sources, can find larger size advantageous. Considerations such as materials of construction, pressure rating, and location of fittings are known or readily identifiable by one of skill in the art.

In some embodiments, an existing tank can be used or a new tank can be used. For example, the system can be installed as a new installation of an LPG fuel system, or only portions can be installed with existing equipment to retrofit or upgrade an existing LPG system.

### Accumulator

An accumulator can be any suitably sized, proportioned, and designed system. In one embodiment, it can be a commercially available accumulator, such as a bladder accumulator or other design made by various manufacturers including OilAir Hydraulics, Inc. However, any device capable of storing a suitable volume of LPG and maintaining sufficient pressure for acceptable delivery of the LPG from the accumulator can be used.

In one embodiment, an OilAir Bladder Accumulator can be used. When the pressure in the storage tank is high, LPG can flow into the accumulator, compressing the bladder and precharged gas on the opposite side of the bladder.

In another embodiment, the accumulator system can be connected to the main fuel tank outlet line without an interposing pressure control unit, non-reverse flow unit or relief valve. In another embodiment the accumulator system can be connected to the main fuel tank outlet line with an interposing pressure control unit, non-reverse flow unit and relief valve. In various embodiments, methods, such as valves, non-reverse flow units, pressure control units, regulators, back pressure regulators, and other techniques can be utilized in order to protect the accumulator from overpressure, to assure flow into the accumulator when desired, flow out of the accumulator when desired and stoppage of flow out of the accumulator when desired. In various embodiments, non-reverse flow units can be check valves of various designs or other units such as valving arrangements, including automatically or manually actuated valving arrangements selected according to the circumstances, and other approaches such as positive displacement pumps/blowers. In various embodiments, regulators and backpressure regulators can be self-actuating or pilot-actuating units or can be valves or control valves, manually, remotely or automatically actuated or positioned, and can in some cases be line restrictions or orifices, etc.

### Heater

Various systems, designs and configurations of heater can be used in the system of the present disclosure, as well as heaters that utilize various operating principles. In one embodiment, a heater can be positioned entirely inside of the storage tank. In another embodiment, a heater can be positioned entirely outside the storage tank. In another embodiment, a heater can be positioned partly inside and partly outside the storage tank.

Suitable heaters include those that can direct heat into a fluid either directly, such as by direct contact with the fluid, or indirectly, such as by contact with another part or material which is in turn in contact, directly or indirectly, with the fluid.

In one embodiment, a heater can include a first heat exchanger and a second heat exchanger, thermally connected by a heat conducting material, such as a heat transfer fluid or a heat conducting conduit, fin, or element. An external energy source can provide a heat inflow at the second heat exchanger, which transfers heat through the heat conducting material to the first heat exchanger, which in turn transfers heat to fuel in the tank.

In some embodiments, the external energy source can be electrical power which provides a heat inflow at the second heat exchanger by utilization of resistive heating or by another technique, such as Peltier heating.

In some embodiments, heat inflow can be provided from exhaust gases, recirculated fluids, such as those used to cool equipment or engines, steam, or other suitable sources of energy or heat.

In some embodiments, an electrical heat source, such as a resistive heating element or a Peltier device can be mounted on the tank to provide heat to the tank and its contents, or mounted inside the tank with some embodiments allowing heat to enter the fluid without passing through the wall of the tank.

In various embodiments, other suitable designs can be used, such as those utilizing immersion heaters, bayonet heaters, and the like.

In one embodiment, the heater can have a heat exchange loop which can utilize a pump and/or a thermal siphon effect to circulate liquid. A liquid to liquid tube & fin heat exchanger can be immersed in the liquid portion of the fuel tank, and a header tank can be used to ensure against vapor lock and allow for expansion and contraction of liquid. The heater and heat exchanger or first and second heat exchangers can be plumbed together in series, while the header tank is connected to the circuit via a Tee connection.

### Control System

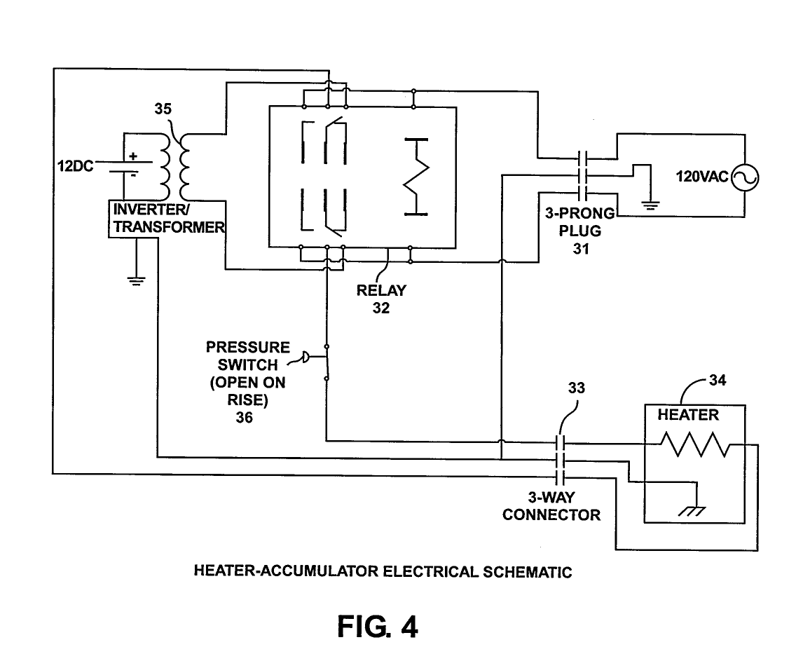

FIG. 4 illustrates a preferred embodiment of a heater-accumulator electrical schematic. This diagram illustrates some of the operating features that can be implemented as a part of the present disclosure.

FIG. 4 displays a dual power system, one which can operate on 120 VAC and 12VDC. While these voltages are convenient in places such as the U.S. for implementation in households with automobiles, other voltages are possible for different situations and locations and can be readily implemented within the system.

### PROPHETIC EXAMPLE 1

### Heater-Accumulator Electrical Control System

An example control system is provided in FIG. 4. In the figure, 120 VAC electrical power is provided at electrical plug 31. Electricity flows to relay 32, through pressure switch 36 (when the storage tank is pressure low), through connector 33 to heater 34. When the 120 VAC power is disconnected at plug 31, relay 32 will switch, and power will be provided from the vehicle's electrical system, flow through inverter/transformer, through relay 32, through pressure switch 36, through connector 33, to heater 34.

When the pressure in the storage tank rises, pressure switch 36 opens and power to the heater is disconnected.

In some embodiments, the inverter/transformer can be moved to the 120VAC system, rather than the vehicle's battery system or provided for both systems. In some embodiments, an electrical interrupt can be provided, such as to provide a manual or automatic switch to disable the battery portion of the system, such as to prevent heating the tank when the motor is not running, and for other reasons and at other points in the system, as desired.

The electrical circuit for the heater includes a normally closed (open on rise) pressure switch that senses main tank pressure. In one embodiment, the switch is configured to open the circuit at approximately 15 psig, and will reclose the circuit in the case of a subsequent drop in pressure at a pressure between 15 and 12 psig.

### PROPHETIC EXAMPLE 2

### Vehicle Installation

The tank heater system operates whenever AC outlet power is provided, such as while the vehicle is parked, and the main tank pressure is below a configured setpoint. The tank heater system also operates while the vehicle is running, and main tank pressure is below a configured setpoint. In this case, while the vehicle is operating, power for the heater is provided by the vehicle's electrical system, which consists of an alternator and battery which are standard with any vehicle, and also a high-power electrical inverter, that converts 12 V DC to the 120 V AC required by the heater. The power source for the heater is automatically switched by a dual pole, dual throw relay, which in its normal (unpowered position) connects the inverter output stage to the heater, and in its power position connects the AC outlet power to the heater. Power to the coil of the relay is provided whenever the AC plug is connected to 120 V AC.

The electrical circuit for the heater includes a normally closed (open on rise) pressure switch that senses main tank pressure. The switch is configured to open the circuit at approximately 15 psig, and will reclose the circuit in the case of a subsequent drop in pressure at a pressure between 15 and 12 psig.

### Operation

Operation of a fuel system as described in the present disclosure can include various manual or automatic checks, inspections, and actions.

In one embodiment, the system, when operating with a sufficiently high pressure in the storage tank to adequately deliver fuel to a fuel consuming unit at a usable pressure, can flow liquid fuel to the accumulator and a volume can be stored in the accumulator for operation during low tank pressures. During low tank pressure operation, the fuel in the accumulator can be forced out of the accumulator to the fuel delivery point. As the fuel flows into the accumulator, if a bladder accumulator is used, the bladder compresses against a gas charge, which can later provide pressure to deliver fuel from the accumulator to the engine or other equipment connected to the system. During high or relatively high vapor pressure operation, as shown in FIGS. 2A and 2B, the fuel can also flows from the storage tank 1 to the fuel delivery point 3. In some embodiments, when the accumulator is sufficiently full, the flow to the accumulator can be stopped and optionally the accumulator can be isolated, such as by valving. In some embodiments, the isolation can be accomplished automatically, manually, or by electronic control system. In some embodiments, only the inlet or only the discharge of the accumulator is isolated. In some embodiments both the inlet and outlet of the accumulator can be isolated. In some embodiments, LPG can continue to flow to the accumulator and LPG can flow out of the accumulator, such as to the fuel delivery point after the accumulator is sufficiently full.

When the pressure in the storage tank is low such as due to a low temperature condition, there is insufficient pressure in the storage tank 1 to deliver sufficient fuel to delivery point 3. In some embodiments the pressure can be less than about 20 psig or less than about 15 psig or less than about 12 psig or less than about 10 psig or less than about 8 psig or less than about 5 psig or less than about 4 psig or less than about 3 psig or less than about 2 psig or less than about 1 psig or less than about 0.5 psig. In some embodiments, the temperature can be less than about 15° C. or less than about 10° C. or less than about 0° C. or less than about −10° C. or less than about −20° C. or less than about −30° C. At this time, the pressure charge in accumulator 6 will push fuel from the accumulator 6, through line 27 and pressure control unit 7 to line 24 and to fuel delivery point 3.

In some embodiments, the amount of fuel that can be delivered from the accumulator will only last for a short time, such as a time sufficient to start the engine and begin operation.

In other embodiments, the amount of fuel that can be delivered from the accumulator tank can last for a longer time, such as a time to drive a particular distance or a time to operate for a time sufficient to warm up the storage tank to an adequate operating pressure, or some other period of time as deemed appropriate.

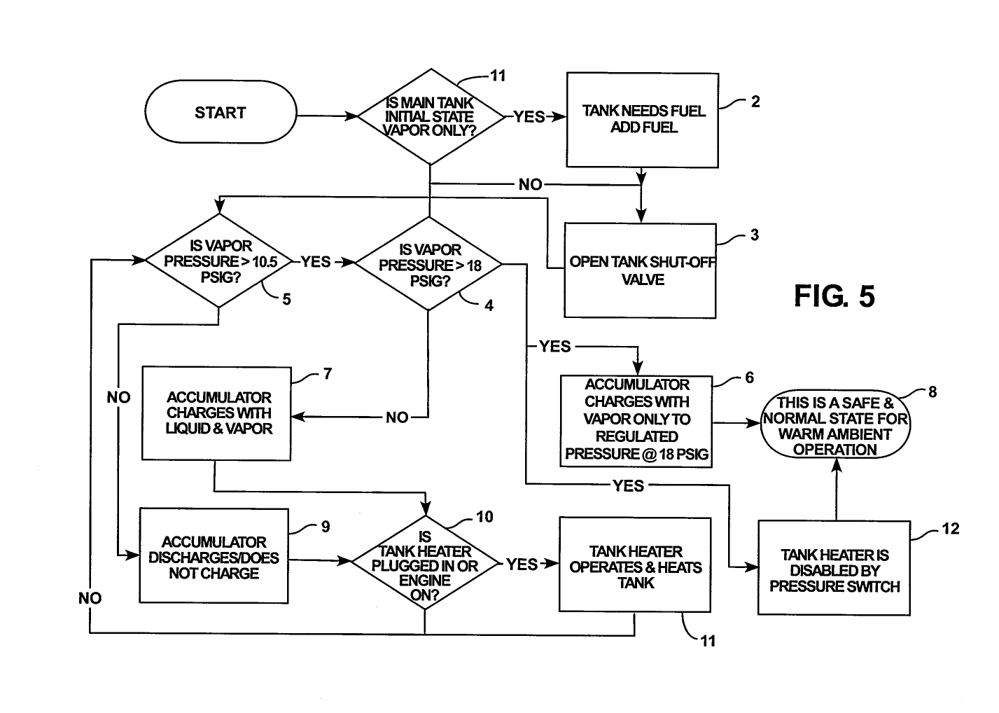

At startup and during operation, different states of fuel vapor pressure, fuel level, and heater operational status can occur and can result in different operating modes as indicated in FIG. 5, where one state can be operation in warm ambient temperature, 8. In some embodiments, there can be a check for liquid fuel in the storage tank 1, with the addition of fuel 2 performed if necessary, opening the outlet valve of the storage tank 3, and operating with one or more of the operating states 7, 9, 6, 11 and 12, in accordance with the vapor pressure status 4 and 5 and power availability to the heater status 10. In some embodiments, different pressures can be used at vapor pressure checks 4 and 5 and state 6, such as where all pressures are higher than those shown, or where all pressures are lower than those shown, or where there is a combination of at least one higher and at least one lower, at least one the same and at least one lower, or at least one the same and at least one higher, or one higher, one lower and one the same. In various embodiments different pressures can be used for various reasons such as the type of device being fueled, the temperature environment, such as the expected temperature, and the formulation of fuel being used. In various embodiments, manual or automatic operation can be utilized as desired.

One embodiment of the operation of an exemplary system is shown as a block diagram in FIG. 5. In this embodiment, there can be a check for liquid fuel in the storage tank 1, with the addition of fuel 2 performed if necessary, opening the outlet valve of the storage tank 3, checking the vapor pressure of the fuel in the tank 4 and 5, and taking action as indicated at 7, 9, 6, and 12. There can also be a check for troubleshooting the heater 10 and 11 and for proceeding to normal operation 8.

In some embodiments, the changeover from operation from the storage tank to the accumulator or from the accumulator to the storage tank can be performed manually, such as by changing the position of one or more valves or by changing the condition of one or more switches, or by issuing a command from a keyboard, touchscreen, or the like. In some embodiments, the changeover from operation from the storage tank to the accumulator or from the accumulator to the storage tank can be performed automatically, such as by sensing one or more operating conditions, one or more environmental conditions, and/or one or more system conditions. Examples of conditions sensed/sensors used can include, but are not limited to the run state of the fuel consuming unit, the storage tank temperature, the storage tank pressure, the fuel line pressure, sensors included in the fuel consuming unit's control system, fuel line temperature, fuel delivery rate, control valve position, regulator position, pressure reducer operation, emissions sensors, sensors related to ancillary equipment such as blowers or pumps, and the like. In some embodiments, the changeover from operation from the storage tank to the accumulator or from the accumulator to the storage tank can be performed with self-actuating devices, such as with check valves, pressure regulators, backpressure regulators, and the like.

In some embodiments, the change from operation from the storage tank to the accumulator can be done manually, while the change from operation from the accumulator to the storage tank can be done automatically. In some embodiments, the change from operation from the storage tank to the accumulator can be done automatically, while the change from operation from the accumulator to the storage tank can be done manually. In some embodiments, both changes can be performed manually or automatically.

In some embodiments, the initiation and termination of filling the accumulator can be performed automatically or manually, with the method of initiation and termination being the same or different. When initiation and termination is automatic, the same or different sensor inputs can be utilized for each.

### Operating Conditions

The operating conditions for the system can depend on the particular fuel, expected ambient conditions, use of the system, and other issues as would be known to a user or a designer of these systems. In some embodiments, the equipment utilizing the fuel will require or be designed for utilizing LPG of a particular pressure, pressure range, or temperature or temperature range. In some embodiments, such as for transportation use, a pressure used by a system can be approximately 20 psig, however, higher or lower pressures can be used as well. In some embodiments, such as for some cooking or heating applications, pressures of about 7 inches WC can be used, but higher or lower pressures can also be utilized in some particular applications. In some applications, for example those utilizing higher fuel volumes and/or rates, a higher pressure can be utilized, such as about 5-20 or about 20-60 or about 50-90 or about 80-150 or about 100-200 psig or even as high as 250 psig or more can be used. Some pressure requirements for systems will be better served with various temperature-fuel composition combinations, such as where higher pressures are required, higher vapor pressure fuels and higher temperatures can be desirable. In addition, some higher pressure applications can also be more sensitive to reduced temperature conditions due to, for example, a reduced pressure condition.

In some embodiments, the normal operating pressure of the storage tank can be a pressure suitable for delivering the LPG to the fuel consuming system at a pressure that can be utilized by the fuel consuming system. In some embodiments, a pressure control unit, such as a valve, regulator, back-pressure regulator, orifice, control valve or other suitable device can be included to reduce the pressure in the storage tank to a suitable level for use by the fuel consuming system. In some embodiments, pressure control units can be capable of limiting, substantially limiting, or completely stopping flow in a reverse direction. In some embodiments, the LPG in the storage tank can be at a pressure that is at a pressure that is sufficiently elevated above an operating pressure of a fuel consuming device to account for line losses or the pressure drop in a control system or a combination of these. In some embodiments, line losses and/or control system pressure loss can be a few inches of water column, or a few psi up to multiple psi. In some embodiments, the line losses and/or control system pressure loss can be 5% or 10% or 20% of the pressure in the storage tank or the pressure after a pressure reducer.

In some embodiments, the maximum pressure of in the storage tank can be elevated over the design requirements of the fuel consuming unit. While the maximum pressure can be as high as a designer chooses, limited by such things as the vapor pressure of the fuel, the wall thickness of the tank, and design of the delivery system.

Generally, with higher molecular weight fuels, lower vapor pressures will be present, and the design will need to accommodate this condition. In some embodiments, the control system set points can be changed in relation to the change in pressure. In some cases, the operating temperature can be raised to increase the pressure.

Generally, lower molecular weight fuels, such as those with less butane will result in higher vapor pressures for a given temperature, and can require higher design pressures for the system, and might call for control system set points changes. In addition, the higher vapor pressure fuels can lead to better low temperature operation, due at least in part to a higher vapor pressure, but can also lead to pressure difficulties at higher temperatures.

As used herein, “fluid” can include liquid, gas, and combinations that include one or both.

In some embodiments, not all features shown in the figures, including FIGS. 2A and 2B, are included. For example, a relief valve 12 may not be included in some embodiments, or a different valve arrangement can be used which eliminates some valves and/or adds others, or a different piping arrangement can be used. Multiple storage tanks, accumulators and delivery points can be accommodated. In addition, other features can be added without departing from the spirit and scope of the present disclosure.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . ”

### Concepts

1. A system for providing LPG fuel to a fuel consuming unit, the system comprising:
   a storage tank configured to contain the LPG fuel;
   a heater configured to transfer heat to at least a portion of the LPG fuel;
   an accumulator configured to receive a portion of the LPG fuel;
   wherein the accumulator can apply pressure to the LPG fuel within the accumulator and the pressure being greater than the vapor pressure of the LPG fuel within the accumulator.
2. The system of Concept 1, further comprising:
   a first flowpath from the storage tank to a fuel delivery point;
   a second flowpath from the accumulator to the fuel delivery point;
   a third flowpath between the storage tank and the accumulator.
3. The system of Concept 2, wherein the first flowpath and the second flowpath at least partially coincide.
4. The system of Concept 2, wherein the first flowpath and the third flowpath at least partially coincide.
5. The system of Concept 2, wherein the first second and third flowpaths at least partially coincide.
6. The system of Concept 2, wherein the second and third flowpaths at least partially coincide.
7. The system of Concept 1, wherein the system is capable of operating in a first mode and a second mode, in the first mode, the LPG fuel is delivered from the storage tank to a fuel delivery point, and in the second mode, the LPG fuel is delivered from the accumulator to the fuel delivery point and the pressure in the accumulator during operation in the second mode is greater than the vapor pressure of the LPG fuel in the accumulator during operation in the second mode.
8. The system of Concept 7, wherein the accumulator is pressurized with an added gas.
9. The system of Concept 8, wherein the added gas is separated from the LPG by a flexible material.
10. The system of Concept 8, wherein the added gas is separated from the LPG by a bladder.
11. The system of Concept 7, wherein the accumulator is a bladder-type accumulator.
12. The system of Concept 7, wherein the second mode allows operation of the fuel consuming unit when the temperature of the LPG fuel in the storage tank is too low to allow operation of the fuel consuming unit with the system operating in the first mode.
13. The system of Concept 12, wherein the second mode allows operation of the fuel consuming unit while the vapor pressure in the storage tank is raised.
14. The system of Concept 7, wherein at least a portion of the LPG in the storage tank is heated during at least a portion of the operation in the second mode.
15. The system of Claim 1, wherein the accumulator is a bladder-type accumulator.
16. The system of Concept 1, further comprising an evaporator configured to convert liquid LPG fuel to gaseous LPG fuel.
17. The system of Concept 1, wherein the system is configured to deliver gaseous LPG to a fuel deliver point.
18. The system of Concept 1, further comprising a controller for switching between utilizing a first energy source and a second energy source, wherein the first and second energy sources provide energy for the heater.
19. The system of Concept 1, wherein the heater is located partially inside and partially outside the storage tank.
20. The system of Concept 1, wherein the heater is located outside of the storage tank.
21. The system of Concept 1, wherein the heater is located inside of the storage tank.
22. The system of Concept 19, wherein the heater comprises:
   a first heat exchanger located at least partially inside the storage tank and in thermal communication with at least a portion of the LPG fuel within the storage tank;
   a second heat exchanger located at least partially outside the storage tank, wherein the second heat exchanger is in thermal communication with the first heat exchanger; and
   a heat source in thermal communication with the second heat exchanger.
23. The system of Concept 19, wherein the heat source is electrical.
24. The system of Concept 18, wherein the controller receives electrical input from the second energy source and switches between the first energy source and the second energy source based on the availability or unavailability of the second energy source.
25. The system of Concept 18, wherein the first or second energy source is electricity at residential voltage.
26. The system of Concept 18, wherein the first or second energy source is electricity at about 100-120 VAC.
27. The system of Concept 18, wherein the first or second energy source is electricity at about 11-15VDC.
28. The system of Concept 24, further comprising an electricity conditioner, wherein the electricity conditioner converts electricity between AC and DC electricity.
29. A vehicle utilizing the system of Concept 1.
30. A system for providing an LPG fuel to a fuel consuming unit, comprising:
   A first LPG fuel delivery route, the first LPG fuel delivery route providing more than about 90% of the LPG fuel consumed by a fuel consuming unit when the LPG fuel exhibits a vapor pressure of less than a first pressure, the first LPG fuel delivery route including an accumulator capable of delivering the LPG fuel at a pressure greater than the vapor pressure of the LPG fuel within the accumulator; and
   A second LPG fuel delivery route, the second LPG fuel delivery route providing more than about 90% of the LPG fuel consumed by the fuel consuming unit when the LPG fuel exhibits a vapor pressure of greater than a second pressure, wherein the first LPG fuel delivery route is not the same as the second LPG fuel delivery route,
   wherein the first pressure is less than the second pressure.
31. The system for providing LPG fuel of Concept 30, wherein the first LPG fuel delivery route and the second LPG fuel delivery route share at least one component.
32. A vehicle utilizing the system of Concept 30.
33. The system for providing LPG fuel of Concept 30, wherein the first pressure is less than about 20 psig or less than about 15 psig or less than about 12 psig or less than about 10 psig or less than about 8 psig or less than about 5 psig or less than about 4 psig or less than about 3 psig or less than about 2 psig or less than about 1 psig or less than about 0.5 psig.
34. A control system for an LPG fuel delivery system, the control system comprising:
   a circuit capable of delivering power to a tank heater from a in an LPG fuel delivery system, and wherein the LPG fuel delivery system comprises a storage tank capable of containing an LPG fuel, a first flow path from the storage tank to a fuel delivery point, a second flow path from the storage tank to the fuel delivery point, an accumulator located along the second flow path, and the tank heater configured to transfer heat to at least a portion of the LPG fuel.
35. The control system of Concept 34, wherein the circuit is capable of switching from a first electrical source to a second electrical source.
36. The control system of Concept 34, wherein more than about 90% of the LPG fuel delivered to the delivery point is delivered from the accumulator when the vapor is less than a first pressure, and more than 90% of the LPG fuel delivered to the delivery point is delivered from the storage tank when the vapor pressure is more than a second pressure, the first pressure being less than the second pressure.
37. The control system of Concept 36, wherein the first pressure is less than about 20 psig or less than about 15 psig or less than about 12 psig or less than about 10 psig or less than about 8 psig or less than about 5 psig or less than about 4 psig or less than about 3 psig or less than about 2 psig or less than about 1 psig or less than about 0.5 psig.
38. The control system of Concept 34, wherein more than about 90% of the LPG fuel delivered to the delivery point is delivered from the accumulator when the LPG is than a first temperature, and more than 90% of the LPG fuel delivered to the delivery point is delivered from the storage tank when the LPG is more than a second temperature, the first temperature being less than the second temperature.
39. The control system of Concept 38, wherein the temperature is less than about 15° C. or less than about 10° C. or less than about 0° C. or less than about −10° C. or less than about −20° C. or less than about −30° C.
40. A system for providing LPG fuel to a fuel consuming unit, the system comprising:
   a storage tank capable of containing an LPG fuel;
   a first flow path from the storage tank to a fuel delivery point;
   a second flow path from the storage tank to the fuel delivery point, wherein the first flowpath and the second flowpath partially coincide;
   an accumulator located along the second flow path, the accumulator configured to deliver LPG fuel at a pressure above the vapor pressure of LPG fuel within the accumulator;
   a heater comprising a resistive electrical heating element, and configured to transfer heat to at least a portion of the LPG fuel, wherein the heater is located partially inside and partially outside the storage tank, and comprises a first heat exchanger located at least partially inside the storage tank and is in thermal communication with at least a portion of the LPG fuel within the storage tank, and a second heat exchanger located at least partially outside of the storage tank and is in thermal communication with the first heat exchanger, and an electrical heat source in thermal communication with the second heat exchanger;
   a controller for switching between utilizing a first energy source and a second energy force, wherein the first and second energy sources provide energy for the heat source, wherein the controller receives electrical input from the second energy source and switches between the first energy source and the second energy source based on the availability or unavailability of the second energy source; and
   an electricity conditioner, wherein the electricity conditioner converts electricity between AC and DC electricity.
41. A vehicle utilizing the system of Concept 40.

What is claimed is:

1. A system for providing LPG fuel to a fuel consuming unit, the system comprising:
a storage tank configured to contain the LPG fuel;
a heater configured to transfer heat to at least a portion of the LPG fuel;
an accumulator configured to receive a portion of the LPG fuel;
wherein the accumulator can apply pressure to the LPG fuel within the accumulator and the pressure being greater than the vapor pressure of the LPG fuel within the accumulator.

2. The system of claim 1, further comprising:
a first flowpath from the storage tank to a fuel delivery point;
a second flowpath from the accumulator to the fuel delivery point;
a third flowpath between the storage tank and the accumulator.

3. The system of claim 1, wherein the system is capable of operating in a first mode and a second mode, in the first mode, the LPG fuel is delivered from the storage tank to a fuel delivery point, and in the second mode, the LPG fuel is delivered from the accumulator to the fuel delivery point and the pressure in the accumulator during operation in the second mode is greater than the vapor pressure of the LPG fuel in the accumulator during operation in the second mode.

4. The system of claim 3, wherein the second mode allows operation of the fuel consuming unit when the temperature of the LPG fuel in the storage tank is too low to allow operation of the fuel consuming unit with the system operating in the first mode.

5. The system of claim 1, wherein the accumulator is a bladder-type accumulator.

6. The system of claim 1, further comprising an evaporator configured to convert liquid LPG fuel to gaseous LPG fuel.

7. The system of claim 1, further comprising a controller for switching between utilizing a first energy source and a second energy source, wherein the first and second energy sources provide energy for the heater.

8. The system of claim 1, wherein the heater is located partially inside and partially outside the storage tank.

9. The system of claim 8, wherein the heater comprises:
a first heat exchanger located at least partially inside the storage tank and in thermal communication with at least a portion of the LPG fuel within the storage tank;
a second heat exchanger located at least partially outside the storage tank, wherein the second heat exchanger is in thermal communication with the first heat exchanger; and
a heat source in thermal communication with the second heat exchanger.

10. The system of claim 8, wherein the heat source is electrical.

11. The system of claim 7, wherein the controller receives electrical input from the second energy source and switches between the first energy source and the second energy source based on the availability or unavailability of the second energy source.

12. The system of claim 11, further comprising an electricity conditioner, wherein the electricity conditioner converts electricity between AC and DC electricity.

13. A vehicle utilizing the system of claim 1.

14. A system for providing an LPG fuel to a fuel consuming unit, comprising:
A first LPG fuel delivery route, the first LPG fuel delivery route providing more than about 90% of the LPG fuel consumed by a fuel consuming unit when the LPG fuel exhibits a vapor pressure of less than a first pressure, the first LPG fuel delivery route including an accumulator capable of delivering the LPG fuel at a pressure greater than the vapor pressure of the LPG fuel within the accumulator; and
A second LPG fuel delivery route, the second LPG fuel delivery route providing more than about 90% of the LPG fuel consumed by the fuel consuming unit when the LPG fuel exhibits a vapor pressure of greater than a second pressure, wherein the first LPG fuel delivery route is not the same as the second LPG fuel delivery route,
wherein the first pressure is less than the second pressure.

15. The system for providing LPG fuel of claim 14, wherein the first LPG fuel delivery route and the second LPG fuel delivery route share at least one component.

16. A vehicle utilizing the system of claim 14.

17. A control system for an LPG fuel delivery system, the control system comprising:
a circuit, wherein the circuit switches power delivered to a tank heater from a first electrical source to a second electrical source in an LPG fuel delivery system, and wherein the LPG fuel delivery system comprises a storage tank capable of containing an LPG fuel, a first flow path from the storage tank to a fuel delivery point, a second flow path from the storage tank to the fuel delivery point, An accumulator located along the second flow path, and a heater configured to transfer heat to at least a portion of the LPG fuel.

18. The control system of claim 17, wherein the LPG fuel in the storage tank exhibits a vapor pressure, and more than 90% of the LPG fuel delivered to the delivery point is delivered from the accumulator when the vapor pressure is less than a first pressure, and more than 90% of the LPG fuel delivered to the delivery point is delivered from the storage tank when the vapor pressure is more than a second pressure, the first pressure being less than the second pressure.

19. A system for providing LPG fuel to a fuel consuming unit, the system comprising:
a storage tank capable of containing an LPG fuel;
a first flow path from the storage tank to a fuel delivery point;
a second flow path from the storage tank to the fuel delivery point, wherein the first flowpath and the second flowpath partially coincide;
an accumulator located along the second flow path, the accumulator configured to deliver LPG fuel at a pressure above the vapor pressure of LPG fuel within the accumulator;
a heater comprising a resistive electrical heating element, and configured to transfer heat to at least a portion of the LPG fuel, wherein the heater is located partially inside and partially outside the storage tank, and comprises a first heat exchanger located at least partially inside the storage tank and is in thermal communication with at least a portion of the LPG fuel within the storage tank, and a second heat exchanger located at least partially outside of the storage tank and is in thermal communication with the first heat exchanger, and an electrical heat source in thermal communication with the second heat exchanger;
a controller for switching between utilizing a first energy source and a second energy force, wherein the first and second energy sources provide energy for the heat source, wherein the controller receives electrical input from the second energy source and switches between the first energy source and the second energy source based on the availability or unavailability of the second energy source; and
an electricity conditioner, wherein the electricity conditioner converts electricity between AC and DC electricity.

20. A vehicle utilizing the system of claim 19.
